(19) United States
(12) Patent Application Publication
(10) Pub. No.: US 2014/0379424 A1
(43) Pub. Date: Dec. 25, 2014

(54) SYSTEMS AND METHODS TO UTILIZE SUBSCRIBER HISTORY FOR PREDICTIVE ANALYTICS AND TARGETING MARKETING

(71) Applicant: Psychability Inc., Nashua, NH (US)

(72) Inventor: Pankaj Shroff, Nashua, NH (US)

(21) Appl. No.: 14/313,229

(22) Filed: Jun. 24, 2014

Related U.S. Application Data
(60) Provisional application No. 61/838,573, filed on Jun. 24, 2013.

(51) Int. Cl. G06Q 30/02

(52) U.S. Cl. CPC G06Q 30/0269; G06Q 30/0202; G06Q 30/0273
USPC 705/7.31

(57) ABSTRACT

Embodiments of the invention relate to computer-implemented methods and systems for managing and analyzing subscriber history data present within a service provider infrastructure. The subscriber history data is free of personally identifiable information and is aggregated according to an anonymous attribute. A predictive model is used to rank a plurality of individuals or households according to one or more household attributes, such as media habits and/or media exposure. Advertisers are provided with access to the ranked data, such that the advertisers can improve marketing metrics for advertisements delivered to the households. Service providers may receive monetary compensation for providing access to the ranked data.

### CROSS-REFERENCE TO RELATED APPLICATION

This application claims priority to and the benefit of, and incorporates herein by reference in its entirety, U.S. Provisional Patent Application No. 61/838,573, which was filed on Jun. 24, 2013.

### TECHNICAL FIELD

Embodiments of the invention relate to methods and systems for providing advertising, and, more specifically, to methods and systems for providing audience information for advertising in television and Internet media, based on the media habits of audience members.

### BACKGROUND

In general, advertisers today plan campaigns that run across different media silos. For example, an advertiser typically decides how to establish a traditional TV campaign, a connected TV (smart TVs, Tablets, etc.) campaign, an Internet display campaign, and a social media campaign. When advertisers wish to run such campaigns across multiple media types, the onus generally falls on the advertising agency to pull all the silos together, after placing individual buys. This process removes any opportunity to leverage synergies that may exist across audiences in the various media silos.

TV advertising is a multi-billion dollar industry that relies heavily on panel or survey-based audience measurement techniques, which measure only a very small sample of the total viewing population. With the advent of digital advertising and digital methods of consuming TV and movie content, the exclusive reliance on panel-based measurements is insufficient. Moreover, with the increasing cross-over between traditional TV and digital media (e.g., Internet display, mobile, social, etc.) consumption, there is an increasing need to achieve cross-media synergies.

Digital advertising is a multi-billion dollar industry that relies heavily on cookie-based data to target the right audience with the right ad. In recent times, however, there has been an exponential increase in the use of cookie-free social media data. Social media data has shown that ad targeting can be accomplished without relying on privacy invasive cookie data.

There is a need for systems and methods that provide actionable audience analytics in traditional media, such as TV, provide less privacy invasive and cookie-free audience information for digital media, such as the Internet, and leverage synergies between traditional and digital media, based on the media habits of target audience members.

### SUMMARY OF THE INVENTION

Compared to previous approaches, the systems and methods described herein provide several advantages. For example, current TV ratings and audience measurement agencies rely primarily on third-party panel-based metrics and decades old TV audience modeling. The systems and methods described herein, however, utilize a proprietary household level media habit and exposure model that is far more computationally efficient and designed to process 100s of millions of records daily. This big data approach is preferably focused on TV service providers who collect first party TV viewing history data for millions of households on weekly, daily, hourly, and minute-by-minute bases.

Compared to off-the-shelf big data technology providers, the systems and methods described herein make it easier for TV providers to deploy a fully automated, big data pipeline for TV, which makes aggregating various proprietary and legacy sources of first party viewing data more streamlined. The big data pipeline also extracts and organizes TV specific psychographic attributes and runs machine learning and predictive analytics algorithms.

Compared to Internet-based display data management platforms and data aggregators, embodiments of the systems and methods described herein employ a cookie-free, purpose-built for TV approach, which highlights TV industry know how. With these systems and methods, media sales can cherry pick audience segments and lookalikes and package or upsell TV ad inventory across multiple platforms. A focus on TV helps penetrate traditional barriers to entry in TV.

In general, embodiments of the invention provide a data monetization pipeline for data collection, aggregation, transformation, analytics, algorithms, and reports, using subscriber history data from service providers. A subscriber ID privacy protection scheme is provided, based on an ephemeral association between data provider and data consumer via ad buyers and sellers, and an irreversible anonymous ID. The systems and methods described herein also provide a household level predictive model, such that each household can be assigned a formula to approximate and predict the household's media habit(s) and exposure in various categories and segments (collectively referred to herein as audience rankings). A real-time data lookup framework is provided for the audience rankings data. In certain implementations, a non-human user recognition system is provided to eliminate non-human user fraud by authenticating if the visiting user is a human user. A real-time data management platform (DMP) is provided that combines various functions described above and exposes user segmentation and authentication through real-time APIs. Embodiments also include a two-sided back-to-back bid exchange (B3E), which acts as an intermediary to enhance real-time bidding offers with proprietary audience segmentation data. An automated cross-media insertion order (IO) placement system and a cross-media campaign execution system are also provided.

In one embodiment of the present invention, the data monetization pipeline, subscriber data anonymization scheme, analytical framework, predictive model, and formulas are made available to service providers so they can create deep marketing intelligence about their subscribers using subscriber history data.

In a specific embodiment, TV audiences are classified into various audience segments based on demographic, media habit, geographic, and time of day information, using supervised machine learning algorithms.

In another embodiment, TV audiences can be re-grouped into audience lookalikes (e.g., a group of audience members having similar media habits and interests), based on similarity between media habits and preferences, and likes and dislikes related to psychographic attributes of content being watched, using unsupervised machine learning algorithms.

In another embodiment, a suite of TV audience analytics services is provided to media sales organizations that sell TV ad inventory available from TV service providers and TV content providers (such as TV programming networks). Such a suite of TV audience analytics services includes, but is not limited to, for example: finding audience segments and lookalikes for specific TV stations or programs; recommending packages of the inventory of advertising supported TV station spots or video on demand ad opportunities for best profitability; and predicting forecast of reach, accuracy, and frequency calculations.

In another embodiment, a real-time data management platform (DMP) is made available to service providers so that they can interface with digital marketing companies, with the intention to monetize the information exposed by the DMP.

In a specific embodiment of a real-time DMP, a standalone DMP service is made available to digital marketing companies, Demand Side Platforms (DSPs) and Supply Side Platforms (SSPs) to help them make real-time ad purchasing decisions by utilizing the system of personalized ranking embedded in the DMP.

In another embodiment, a back-to-back bid exchange (B3E) service is made available to the real-time bidding (RTB) industry participants, such that the DMP functionality embedded within the B3E is used to enhance and re-price bid offers using the system of personalized ranking in the DMP.

In the preferred embodiment of this invention, a cross-media DSP, which embeds an automated cross-media IO placement and cross-media campaign execution system, is made available to digital marketing companies, such that an automated cross-media IO can be placed and managed throughout its lifetime. The system executes cross-media campaigns defined by the cross-media IO and makes media spend decisions in multiple media channels in real-time as the campaign progresses based on media habit, media exposure and personalized ranking information from the real-time DMP embedded within the DSP.

In one aspect, the invention relates to a computer-implemented method for managing and analyzing subscriber history data present within a service provider infrastructure. The method includes: removing elements from the subscriber history data that allow the data to be attributed to a household; aggregating the subscriber history data by an anonymous attribute; deriving a predictive model for a plurality of households; ranking each household in the plurality of households relative to other households according to one or more household attributes; in real-time, providing advertisers with access to the ranked data such that the advertisers can improve marketing metrics for advertisements delivered to the households, and receiving monetary compensation for providing access to the ranked data.

In certain implementations, the service provider includes a multiple service operator, a cable service provider, a telephone company, a mobile network operator, and/or a wireless service provider. The household may include a family and/or an individual subscriber. In some instances, removing elements from the subscriber history data includes removing personally identifiable information from the subscriber history data.

In various embodiments, the predictive model is configured to predict media habit(s) and media exposure for one or more households. The one or more household attributes may include a media habit and/or a media exposure. Ranking each household relative to other households may include assigning a formula to predict a household's media habit and exposure. Ranking each household relative to other households may include assigning a household to a demographic segment and/or a group of lookalike households (lookalikes) having similar media viewing habits and/or psychographic attributes, such as mood, theme, and/or genre of programs viewed.

In another aspect, the invention relates to a system that includes a computer readable medium having instructions stored thereon, and a data processing apparatus configured to execute the instructions to perform operations. The operations include: removing elements from the subscriber history data that allow the data to be attributed to a household; aggregating the subscriber history data by an anonymous attribute; deriving a predictive model for a plurality of households; ranking each household in the plurality of households relative to other households according to one or more household attributes; in real-time, providing advertisers with access to the ranked data such that the advertisers can improve marketing metrics for advertisements delivered to the households; and receiving monetary compensation for providing access to the ranked data.

In certain implementations, the service provider includes a multiple service operator, a cable service provider, a telephone company, a mobile network operator, and/or a wireless service provider. The household may include a family and/or an individual subscriber. In some instances, removing elements from the subscriber history data includes removing personally identifiable information from the subscriber history data.

In various embodiments, the predictive model is configured to predict media habit(s) and media exposure for one or more households. The one or more household attributes may include a media habit and/or a media exposure. Ranking each household relative to other households may include assigning a formula to predict a household's media habit and exposure. Ranking each household relative to other households may include assigning a household to a demographic segment and/or a group of lookalike households (lookalikes) having similar media viewing habits and/or psychographic attributes, such as mood, theme, and/or genre of programs viewed.

In another aspect, the invention relates to a computer program product stored in one or more storage media for controlling a processing mode of a data processing apparatus. The computer program product is executable by the data processing apparatus to cause the data processing apparatus to perform operations including: removing elements from the subscriber history data that allow the data to be attributed to a household; aggregating the subscriber history data by an anonymous attribute; deriving a predictive model for a plurality of households; ranking each household in the plurality of households relative to other households according to one or more household attributes; in real-time, providing advertisers with access to the ranked data such that the advertisers can improve marketing metrics for advertisements delivered to the households; and receiving monetary compensation for providing access to the ranked data.

In certain implementations, the service provider includes a multiple service operator, a cable service provider, a telephone company, a mobile network operator, and/or a wireless service provider. The household may include a family and/or an individual subscriber. In some instances, removing elements from the subscriber history data includes removing personally identifiable information from the subscriber history data.

In various embodiments, the predictive model is configured to predict media habit(s) and media exposure for one or more households. The one or more household attributes may include a media habit and/or a media exposure. Ranking each household relative to other households may include assigning a formula to predict a household's media habit and exposure. Ranking each household relative to other households may include assigning a household to a demographic segment and/or a group of lookalike households (lookalikes) having similar media viewing habits and/or psychographic attributes, such as mood, theme, and/or genre of programs viewed.

Elements of embodiments described with respect to a given aspect of the invention may be used in various embodiments of another aspect of the invention. For example, it is contemplated that features of dependent claims depending from one independent claim can be used in apparatus and/or methods of any of the other independent claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

While the invention is particularly shown and described herein with reference to specific examples and specific embodiments, it should be understood by those skilled in the art that various changes in form and detail may be made therein without departing from the spirit and scope of the invention.

FIG. 1 is a schematic diagram of a data monetization pipeline, in accordance with certain embodiments of the invention.

FIG. 2 is a schematic diagram of a subscriber ID anonymization scheme, in accordance with certain embodiments of the invention.

FIG. 3 is a schematic diagram of a real-time audience rankings lookup framework, in accordance with certain embodiments of the invention.

FIG. 4 is a schematic diagram of a non-human traffic recognition scheme, in accordance with certain embodiments of the invention.

FIG. 5 is a schematic diagram of a real-time data management platform, in accordance with certain embodiments of the invention.

FIG. 6 is a schematic diagram of a back-to-back bid exchange, in accordance with certain embodiments of the invention.

FIG. 7 is a schematic diagram of a cross-media automated insertion order placement system, in accordance with certain embodiments of the invention.

FIG. 8 is a schematic diagram of an example fully integrated real time bidding system, in accordance with certain embodiments of the invention.

### DESCRIPTION OF THE INVENTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

Throughout the description, where apparatus and systems are described as having, including, or comprising specific components, or where processes and methods are described as having, including, or comprising specific steps, it is contemplated that, additionally, there are apparatus and systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

As used herein, in certain embodiments, “cable multi service operator” (MSO) is understood to mean any service provider that offers subscribers within its regions of coverage multiple communications and content services such as multi-channel cable television, high speed cable based Internet access, and Internet based voice communications.

As used herein, in certain embodiments, “telecom operator” (Telco) is understood to mean any service provider that offers subscribers within its regions of coverage telephony services, high speed copper or fiber based broadband (internet access) and multi-channel television services.

As used herein, in certain embodiments, “mobile network operator” (MNO) is understood to mean any service provider that offers its subscribers within its regions of coverage mobile telephone and high-speed wireless broadband services. Some MNOs also provide content services to subscribers.

As used herein, in certain embodiments, “service provider” is understood to mean any multiple service operator (MSO), cable service provider, telecom operator (Telco), mobile network operator (MNO), or wireless service provider.

As used herein, in certain embodiments, “ISP” (Internet Service Provider)” is understood to mean any service provider that provides internet connectivity services to subscribers or households in its region.

As used herein, in certain embodiments, “IP Address” is understood to mean an Internet protocol address that uniquely identifies a given device connected to the internet. IP addresses for subscriber devices are usually issued by their ISPs.

As used herein, in certain embodiments, “subscriber data” is understood to mean information regarding registered subscribers of any service provider—usually demographic or Personally Identifiable Information (PII), as described herein.

As used herein, in certain embodiments, “subscriber viewing history data” is understood to mean a historical record of each transaction initiated by the subscriber resulting in content consumption of any form. The content consumption may include, for example, viewing a show using linear TV, video on demand, time-shifted TV, network DVR, and/or TV everywhere services.

As used herein, in certain embodiments, “subscriber web browsing history data” is understood to mean a historical record of each transaction initiated by the subscriber resulting in information exchange of any form. The transaction may include, for example, browsing a website, clicking on an ad, searching for information, and/or posting a social media update.

As used herein, in certain embodiments, “digital marketing companies” is understood to mean advertising agencies, advertisers (brands), or merchants who market products they sell through digital advertising.

As used herein, in certain embodiments, “social media” is understood to mean the advertising and publishing medium created by social networks of users hosted in the World Wide Web accessible to users from any Internet connected device (e.g., PC, TV, or mobile).

As used herein, in certain embodiments, “display advertising” is understood to mean a medium of digital advertising in which marketing messages are embedded in the form of banners, side bars, and/or overlays in web page content.

As used herein, in certain embodiments, “TV advertising” is understood to mean a medium of traditional advertising in which marketing messages are embedded in the form of video commercials interleaved between TV programming or on-demand shows.

As used herein, in certain embodiments, “real-time bidding” (RTB) is understood to mean a method of buying and selling ad placement opportunities through an auction process. An ad placement opportunity is created when a user visits a web page on a site that is affiliated with an ad exchange. The ad exchange offers this opportunity in an auction to registered buyers who are willing to place bids. The buyers' bidding logic determines which bid offer to respond to with a bid, what the price of the bid should be, and what kind of ad is to be selected to show to the visiting user. This process is referred to as “real-time” because all of this completes before the browser on the visitor's device finishes loading the web page being visited.

As used herein, in certain embodiments, “supply side platform” (SSP) is understood to mean a service that sends bid offers to demand side platforms (DSPs) when a user visits a web page on a site affiliated with that service.

As used herein, in certain embodiments, “demand side platform” (DSP) is understood to mean a service that receives bid offers from the supply side platform (SSP) and determines if it should respond back with bids. If the DSP bidder determines that a bid is to be placed, it also must determine what price to bid. Often the bidding logic uses additional data about the visitor when placing a bid.

As used herein, in certain embodiments, “programmatic advertising” (sometimes referred to as simply “programmatic”) is understood to mean buyers and sellers of ad opportunities utilizing an ad buying and selling environment, within which some form of RTB is used. This environment is referred to as programmatic advertising.

As used herein, in certain embodiments, “insertion order” (JO) is understood to mean an instruction from an ad agency or an advertiser (brand) to a publisher about the budget, campaign, duration, and/or target of a media campaign. The IO is usually in the form of a spreadsheet.

As used herein, in certain embodiments, “automated IO” is understood to mean an insertion order placed by an ad agency or an advertiser (brand) through computerized or otherwise digitally automated systems with little human intervention.

As used herein, in certain embodiments, “cross media campaign” is understood to mean a media campaign that is executed across the boundaries of two categories of communications media. For example, a cross-media campaign may be one in which Brand B chooses to spend X amount of money on the TV advertising medium, and Y amount of money on the display advertising medium. The selection of X and Y is done carefully to maximize the return on investment of the total ad budget to achieve an effective cross media campaign.

As used herein, in certain embodiments, “data management platform” (DMP) is understood to mean a system that aggregates and analyzes user data with the intention to expose additional and more current information about the user to assist with ad purchase and ad selection decisions. A DMP may expose this information to either a DSP or an SSP.

As used herein, in certain embodiments, “demographic targeting” is understood to mean a method of grouping audiences based on their gender, age, race, life cycle stage, and/or income level, and targeting such demographic segments.

As used herein, in certain embodiments, “psychographic targeting” is understood to mean a method of grouping audiences based on their likes or dislikes, behavioral characteristics, viewing history, browsing history, etc., and targeting such psychographic segments.

As used herein, in certain embodiments, “geographic targeting” is understood to mean a method of grouping audiences based on their geographical location (e.g., country, state, county, region, zip code, city, street address, and/or GPS location coordinates).

As used herein, in certain embodiments, “personally identifiable information” (PII) is understood to mean information about a user or subscriber, which is deemed to be private and/or may be used to identify the particular user or subscriber. PII may include, for example, explicit personal information provided by the user, demographic information, and exact geographic location (such as GPS). Subscriber data is considered to be or include PII. Subscriber viewing and browsing history data is not usually considered PII.

Embodiments of the invention provide systems and methods that facilitate an exchange of data related to media habits and media exposure of individuals, groups of individuals, and households. On behalf of cable service providers, TV networks, smart TV manufacturers, and other providers of media services and equipment, the data exchange enables audience data to be exchanged in return for monetary compensation.

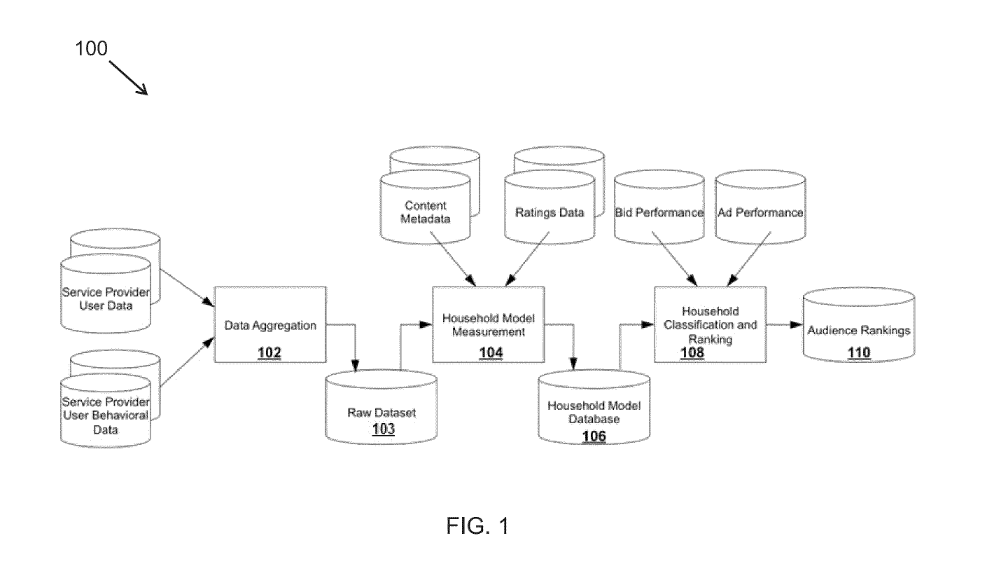

Referring to FIG. 1, in certain embodiments, a data monetization pipeline 100 for service providers is a framework or system for data aggregation and analytics that enables a service provider to transform the data it holds about subscriber behavior into a monetizable asset. For example, using the data monetization pipeline 100, a cable service provider may be able to provide data to buy side and sell side participants of the advertising industry (e.g., both TV and Internet), regarding media habits and media exposure of its subscribers. The buy side and sell side participants may provide monetary compensation to the cable service provider in exchange for the data.

The data monetization pipeline 100 includes a data aggregation subsystem 102 that produces a warehouse of aggregated data from several service provider data sources for further modeling and analysis in the form of a raw dataset 103. The data sources may be originally in formats that are proprietary to the service provider's unique data collection environment. Some components of this subsystem can be optionally co-located with the service provider's own equipment, which in turn can be distributed across multiple sites. A household model measurement subsystem 104 recombines and mines through the raw dataset 103 and any other relevant third party data (such as content metadata, ratings data, etc.). The household model measurement subsystem 104 computes values for a set of variables to measure or predict a household's or an individual's media habits and exposure, based on past data collected for the household or individual. For example, the household model measurement subsystem 104 may statistically analyze previous media viewing habits (e.g., types of TV shows and time of day TV shows are viewed) of a household in an effort to predict when the household may view or be exposed to various types of media again in the future. A household model database 106 stores computed values and results from the household model measurement subsystem 104 for measuring or predicting media habit and media exposure in multiple dimensions (e.g., types of media, and time of media exposure) for each household. A household classification and ranking subsystem 108 is a set of predictive learning and personalized ranking algorithms that assign a score to each household in multiple categories based on the data computed in the household model measurement subsystem 104 and any feedback data related to bid performance and/or ad performance. A rankings database 110 holds rankings, scores, and recommendations, and is made available to external systems.

The benefits of the data monetization pipeline 100 go beyond better targeting of advertisements. For example, ad sales groups within a TV network can use the audience data to package inventory more intelligently and profitably. On the buy side, media planning and budgeting for cross-media campaigns may benefit from the data.

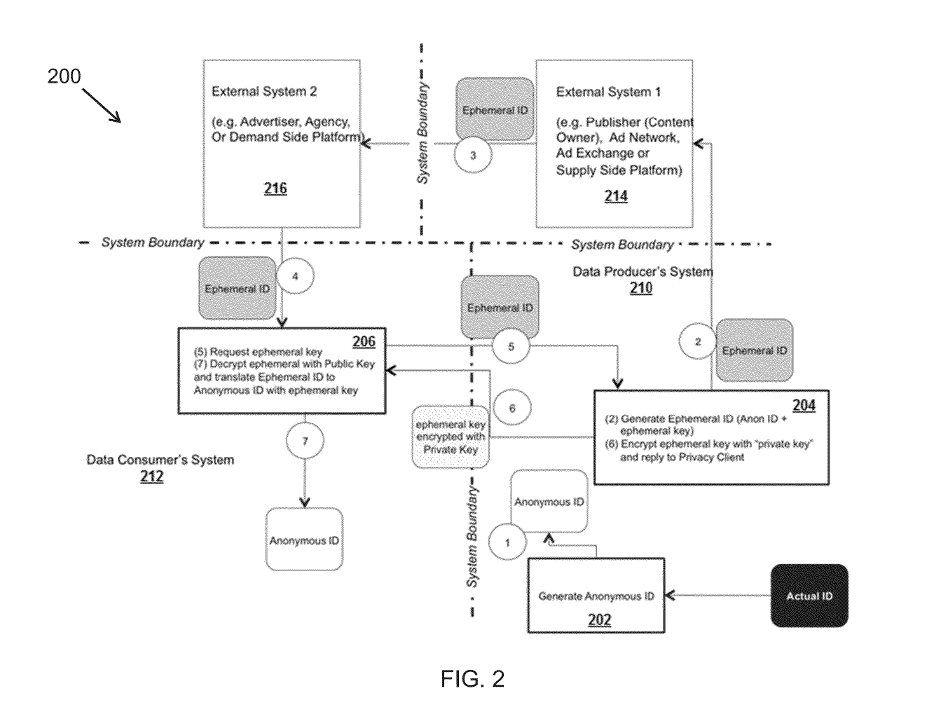

Referring to FIG. 2, in certain embodiments, a subscriber ID anonymization scheme 200 defines or includes a method and system established between a data producer system 210 and a data consumer system 212 to ensure that an original actual ID (e.g., of a subscriber or user) is never revealed outside the data producer's own system 210 and cannot be inferred by intermediary systems. An exemplary data producer may be a service provider that records subscriber history data indexed by the subscriber's actual ID or an anonymous ID. The scheme 200 defines or includes a specific set of steps (1) through (7) and an anonymous ID generator 202, a privacy proxy 204, and a privacy client 206.

The anonymous ID generator 202 is typically installed in the data producer's system 210 and generates an anonymous ID for every actual ID (step 1). The anonymous ID is preferably never shared with intermediary systems (e.g. DSP or SSP) and may be shared only with approved data consumers. This ensures there is no PII traceable back from the anonymous ID or from the data indexed by the anonymous ID.

The privacy proxy 204 is typically installed in the data producer's system 210 and generates a unique, one-time only, time-based random key, referred to as an ephemeral key. The privacy proxy encrypts the anonymous ID using this ephemeral key and saves the ephemeral key to be shared securely only with authorized clients. This encrypted form of the anonymous ID is shared with external third party systems 214 as an ephemeral alias to the anonymous ID (i.e. an ephemeral ID) (step 2). To prevent intermediaries from learning (or caching) ephemeral IDs, the ephemeral key is generated randomly, so that the ephemeral ID is different each time.

The privacy client 206 requests the encryption key of the ephemeral ID from the privacy proxy 204. The privacy client 206 preferably possesses a digital certificate from the data producer (i.e. the data producer's certified “public key”). When the privacy proxy 204 receives a request for the ephemeral key, it recovers the ephemeral key that was used to generate the ephemeral ID in step 2, encrypts this ephemeral key with its “private key,” and returns the encrypted ephemeral key to the requesting privacy client (step 6).

The privacy client 206 is preferably installed in the data consumer's system 212 and possesses a digital certificate from the data producer (i.e. the data producer's certified “public key”). The certificate is preferably generated by the data producer, signed by a certificate authority, and programmed into the data consumer's system 212 a-priori. The data consumer's system 212 receives the ephemeral ID as part of a request from an external system 216 (step 4). The privacy client 206 in the data consumer's system 212 requests the privacy proxy 204 in the data producer's system 210 for the ephemeral key (step 5). An encrypted ephemeral key is received in response from the privacy proxy 204. The privacy client 206 uses the data producer's “public key” that it possesses a-priori, to decrypt the ephemeral key (step 6). The privacy client 206 then uses this ephemeral key to decrypt the ephemeral ID into the anonymous ID and uses the anonymous ID to access data associated with the anonymous ID (step 7). The ephemeral ID may be provided from the external third party systems 214 to the external systems 216 (step 3).

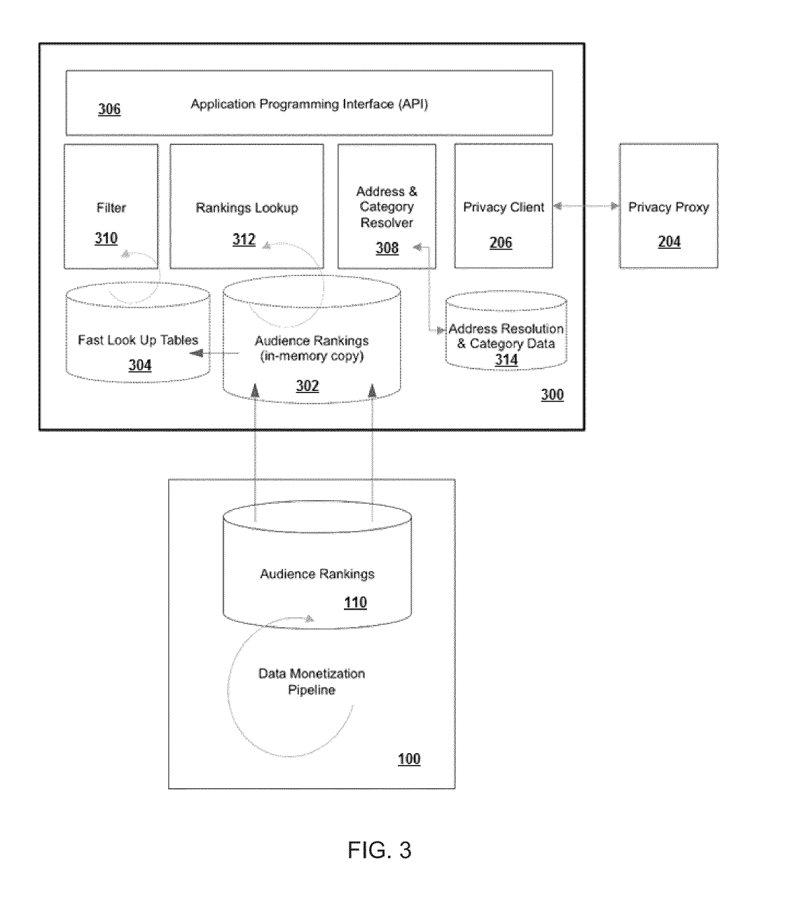

Referring to FIG. 3, in certain embodiments, a real-time audience rankings lookup framework 300 or system is designed to enable extremely fast lookup of audience rankings in audience segments (e.g., demographic, psychographic, geographic) or other dimensional categories, such as time window, ad category, content genre, or rating, etc. In general, in the digital advertising industry, there is increasing reliance on auction-based real-time bidding on exchanges that supply ad opportunities. Decisions regarding whether to bid, how much to bid, and which ad to place against a set of opportunities being auctioned typically need to be made quickly (e.g., within 200 milliseconds). Advantageously, the real-time audience rankings lookup framework 300 can be queried to obtain audience data in a much shorter time, thereby enabling the bidding side (i.e., the buy side) to make better real-time bidding decisions.

In general, the real-time audience rankings lookup framework 300 is defined as “real-time” because the lookup times and response times are typically in the order of milliseconds (e.g., less than 100 ms). The framework 300 utilizes an in-memory copy 302 of the audience rankings 110, kept up-to-date in the data monetization pipeline 100.

The in-memory database copy of audience rankings database 302 is maintained in a real-time lookup framework. The real-time lookup framework may not reside in the same physical or virtual machine as the data monetization pipeline 100. Hence, a periodic synchronization process is defined or used to keep the original audience rankings database 110 and its in-memory copy 302 in the real-time lookup framework synchronized.

A set of fast lookup tables 304 are maintained and updated based on data retrieved from the in-memory copy of the audience rankings 302. The primary purpose of the fast lookup tables 304 is to further dice the data from the audience rankings 302 into dimensions, aggregations and indexes that are most often accessed and can be easily filtered.

An application programming interface (API) 306 is included to allow external systems to access the audience segmentation data in “real-time” (e.g., less than 100 milliseconds response time). An exemplary external system requesting such information may be a DSP or an SSP in possession of a valid ephemeral ID for the visiting user, which can then be translated into a valid anonymous ID, and the user's ranking scores against demographic, psychographic, and geographic segments can be obtained. Any other media habit and media exposure information in various dimensions (such as program title, ad title, program genre/rating, ad category, etc.) can also be obtained in a similar manner. The ephemeral ID received in such an API request is resolved to the anonymous ID with the help of the privacy client 206, which can securely communicate with the privacy proxy 204 to assist with the resolution.

An address and category resolver 308 resolves the public address identifying the visiting user's terminal (e.g., a device such as a TV, set top box, PC, or mobile phone) into the service provider that issued such an address. The address resolver 308 may use an address resolution and category database 314 internal to the framework or may connect to an external service for such purpose. The IP address resolved to its corresponding service provider allows the privacy client 206 to connect to the correct privacy proxy 204 and also for the in-memory audience rankings database 110, 302 to be synchronized with the correct data monetization pipeline 100 in the corresponding service provider. Similarly, the address and category resolver 308 is designed to resolve content categories and ad categories designated in the API request into category identities defined in the audience rankings database. This allows external systems to request rankings based on specific category dimensions in a consistent manner.

A filter algorithm 310 accelerates the lookup further by filtering out requests for non-existent data more rapidly. The principle behind the filter algorithm 310 is to eliminate unnecessary searches for records that do not exist in the accessible data sets. An exemplary filter algorithm 310 that may be used is a bloom filter. In general, a bloom filter is or utilizes a probabilistic algorithm that guarantees the algorithm will accurately and efficiently determine when specific data does not exist in the filter's data structure. Such filter algorithms with their corresponding data structures may be implemented and/or used to further improve the real-time nature of the audience rankings lookup framework.

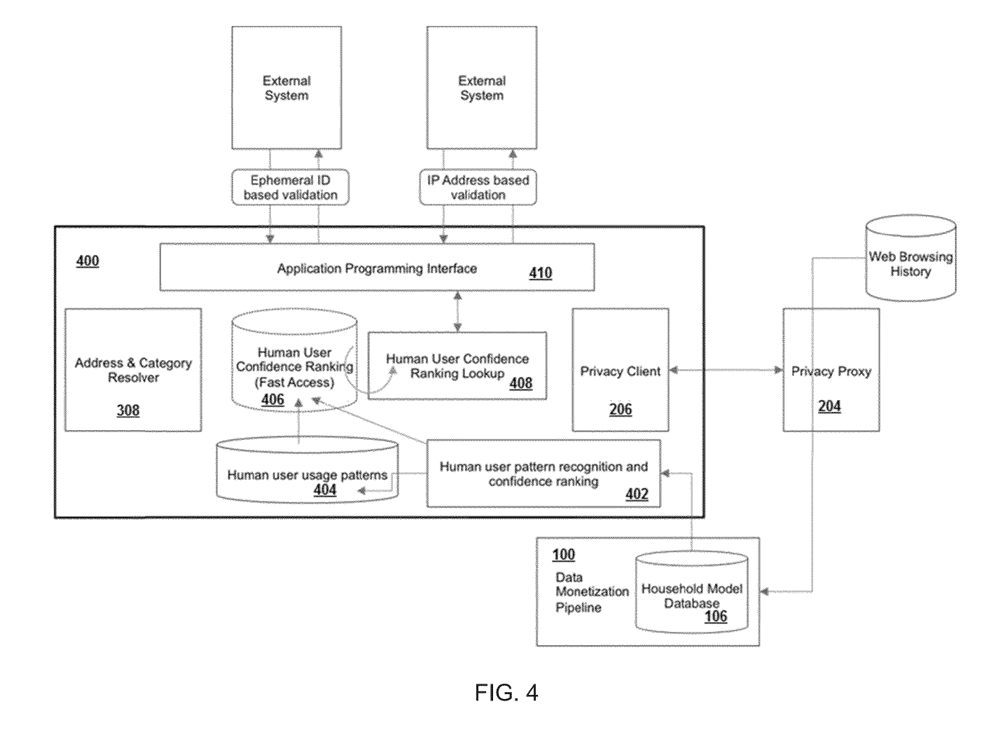

Referring to FIG. 4, in certain embodiments, a non-human traffic recognition scheme 400 or system utilizes pattern recognition on the data in the household model database 106 to determine human versus non-human usage behavior, and produces a human user confidence ranking Based on this confidence ranking and other privacy protection schemes described herein (e.g., the subscriber ID anonymization scheme 200, the anonymous ID generator 202, the privacy proxy 204, and/or the privacy client 206), an external system can validate if the visiting user for a particular web destination is a human or non-human (botnet) fake user.

The non-human traffic recognition scheme 400 includes a human user pattern recognition and confidence-ranking algorithm 402 that analyzes the household model database 106 of the data monetization pipeline 100. The algorithm 402 is able to recognize media habit and media exposure that is either consistent with the known human media habit and exposure or is inconsistent with the known human media habit and exposure. For example, when a household's historical media habit and exposure data indicate the household is more interested in action movies, and that the household usually watches action movies or TV shows during late evenings or weekends, the non-human traffic recognition scheme 400 may conclude that the household likely includes a male viewer. A probabilistic score may be added to or subtracted from a baseline human user pattern score. The history may be continuously analyzed and confidence rankings continuously evaluated thus catching non-conforming and potentially fraudulent behavior. Any false alarms (e.g., inconsistent but valid behavior indicated by a change in preferences or lifestyles of household) may be detected through noise filtering, time-series based algorithms.

The non-human traffic recognition scheme 400 includes a human user usage patterns database 404 that stores all consistent and inconsistent media habit and exposure measurements, as well as a history of those measurements. The human usage patterns database 404 also records and stores confidence rankings over time.

The non-human traffic recognition scheme 400 also includes a human user confidence ranking in-memory database 406 for fast lookup and response. The human user confidence ranking in-memory database 406 is kept synchronized with the human usage patterns database 404 and further fast access data sets are recomputed. The fast access data sets may be indexed and searched for near real-time access. In some implementations, the in-memory database 406 is across a physical system boundary from the human usage patterns database 404.

A human user confidence rankings fast lookup algorithm 408 is also included in the non-human traffic recognition scheme 400. The human user confidence rankings fast lookup algorithm 408 utilizes the in-memory database 406 and further implements filters, search indexes and/or caching to respond to queries from an application programming interface (API) 410.

The API 410 is defined so that external systems can programmatically query non-human traffic recognition scheme 400 for human user confidence rankings and/or non-human user detection. There are two types of APIs for validating human versus non-human users. The first API makes use of the ephemeral IDs described herein (e.g., with respect to the subscriber ID anonymization scheme 200, the anonymous ID generator 202, the privacy proxy 204, and/or the privacy client 206). A request with an ephemeral ID embedded in it guarantees that the API response will in all certainty verify whether the ephemeral ID corresponds to a human user or not. If the ephemeral ID can be resolved to a valid anonymous ID, then without identifying the actual user, it can be ascertained that this is a genuine human user. The address and category resolver 306 and the privacy client 204 may be used to do the translation form ephemeral ID to anonymous ID. In addition to a definitive yes or no answer, a human user confidence ranking may be supplied in the response.

Alternatively or additionally, the second type of API is presented that allows human user validation merely via a public address available to the requestor. The public address itself can be ephemeral (e.g., it is not statically bound to a user's device). The address resolver 306 may be used to translate the address to the issuer of the address (e.g., the ISP). If the particular issuer or ISP is a data partner, the privacy client 204 may use a specially encoded time-based algorithm to regenerate the ephemeral ID for the address. For example, the specially encoded time-based algorithm may not allow the ephemeral ID to be regenerated (e.g., may return an error) if a predetermined time period (e.g., 30 minutes) has expired. The regenerated ephemeral ID is then validated and resolved to an anonymous ID. As in the previous case, the ephemeral ID must resolve to a valid anonymous ID. If the ephemeral ID resolves to a valid anonymous ID, then the response is a definitive yes or no along with a human user confidence ranking. If the ephemeral ID does not resolve to a valid anonymous ID, then the response is ambiguous and other mechanisms (e.g., provided by third parties) may be used to further verify the user's authenticity.

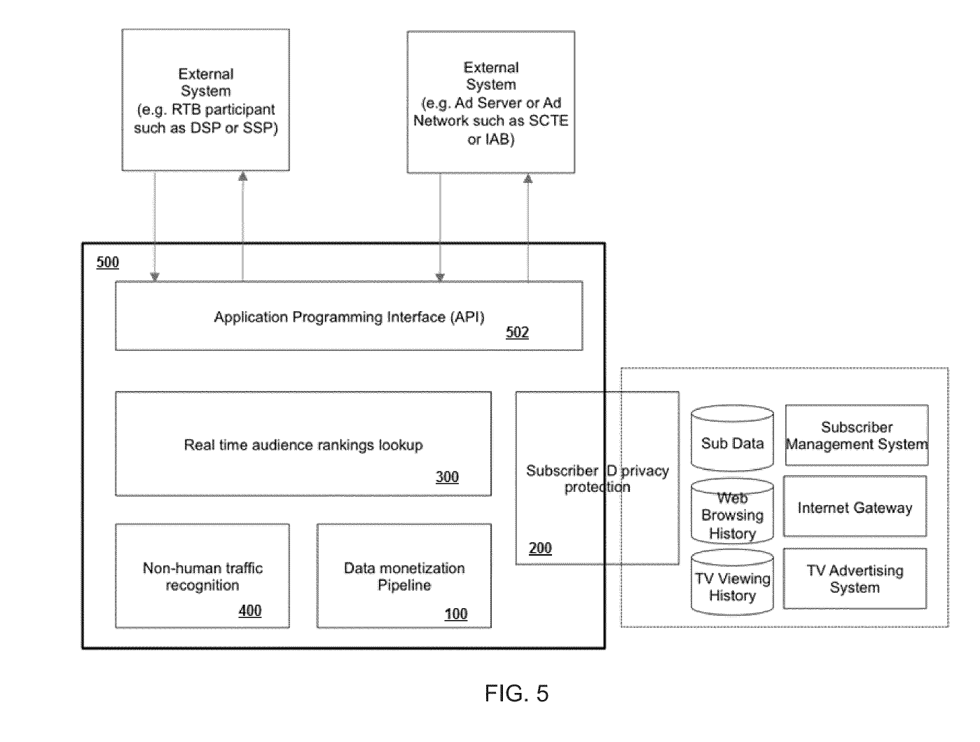

Referring to FIG. 5, in certain embodiments, a real-time data management platform (DMP) 500 or system encapsulates the data monetization pipeline 100, optionally the subscriber ID privacy protection scheme 200, the real-time audience rankings lookup framework 300, and optionally a non-human user recognition engine 400, each of which is accessible through an application programming interface (API) 502.

The API 502 is included to share real-time audience information with external systems, such as a real-time bidding participant (e.g., a demand side platform or a supply side platform) or any other ad server or ad network, whether in the Internet advertising ecosystem (IAB), in the cable and telecommunications ecosystem (SCTE), or any other media and sales format.

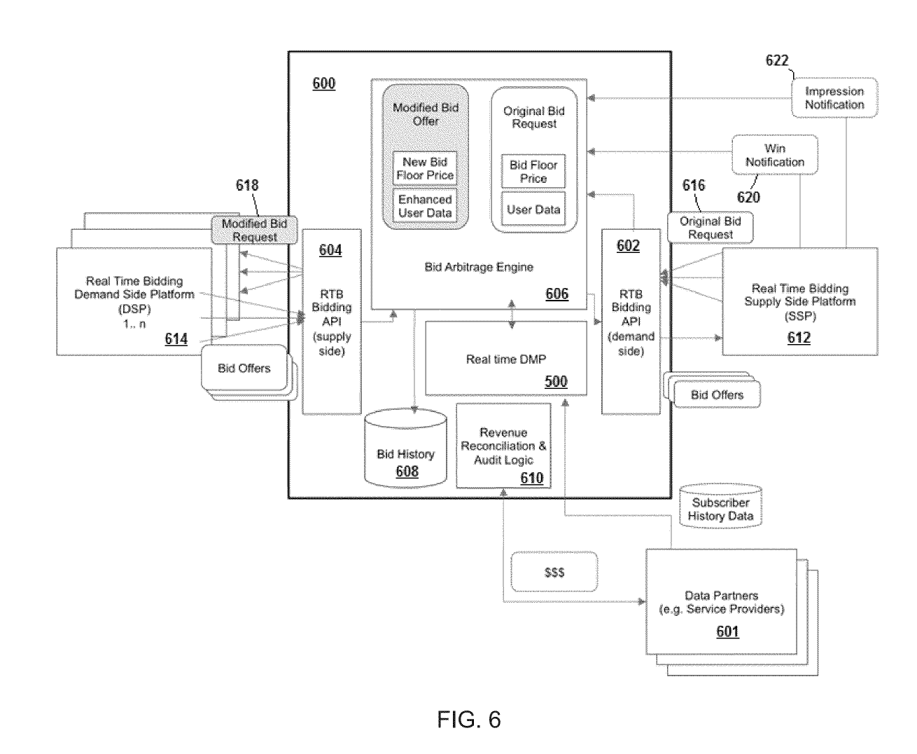

Referring to FIG. 6, in certain embodiments, a back-to-back bid exchange (B3E) 600 or system creates a market for service provider originated audience data in a real-time bidding (RTB) ad buying process. Audience data from a service provider 601 is collected, analyzed, and shared in advertiser friendly forms using a real-time DMP 500. The B3E 600 makes it possible to monetize this audience data, such as the audience rankings 110, 302 during a real-time bidding (RTB) transaction.

On the buy side of an RTB transaction, the B3E 600 registers as a demand side platform (DSP) to an external supply side platform (SSP) 612 or exchange in an RTB marketplace. The external SSP 612 sends original bid requests 616 to the B3E 600, for example, in a manner that is the same as or similar to a manner used to send original bid requests 616 to other registered DSPs. On the sell side, the B3E 600 appears as a supply side platform (SSP) or an exchange to one or more DSPs 614.

Using a bid arbitrage engine 606, the B3E 600 enhances selected bid requests to include additional audience data, and manages the bid request arbitration as the intermediary between SSPs 612 and DSPs 614. A demand side of an RTB API 602 (also referred to as the bidder) receives bid requests from the SSPs 612 over a standard interface and eventually responds to the requests with bid offers it has received. A supply side of an RTB API 604 (also referred to as the exchange) sends bid requests to DSPs 614 over a standard interface and receives responses to these requests.

In general, the bid arbitrage engine 606 evaluates bid requests received from SSPs 612 and determines if the bid requests can be enhanced with additional audience and/or user data from the real-time DMP 500. For each original bid request 616, the bid arbitrage engine 606 uses additional audience and user information available through the real-time DMP 500 and makes a re-evaluation of the original bid request 616 and bid price. If the bid arbitrage engine 606 determines that the bid request should be modified to include additional audience data and a different bid floor price, a modified bid request 618 may be generated with this additional information. The value of the enhancement is computed based on a data-pricing scheme and the bid floor price may be updated accordingly.

In general, the data-pricing scheme may assign different weights to different pieces of information that may be inferred about households. For example, when the systems and methods have a high level of confidence about a demographic profile of a household (e.g., a head of household), that demographic profile may be weighed higher. Likewise, when the systems and methods have psychographic information, such as “this person is a binge viewer” or “this person watches action movies,” a higher weight may be assigned to the psychographic information, depending on the confidence ranking. In some instances, lower weights are attached to unrelated information, such as when a bid request relates to automobiles but a household also has an appetite for kitchen appliance ads.

The modified bid request 618 is then sent via the supply side of the RTB API 604 to DSPs 614. If, for some reason, it is determined that the original bid request 616 cannot be enhanced with additional data available from the real-time DMP 500, the original bid request 616 may be sent as is to the DSPs 614 via the supply side of the RTB API 604. A history of the bid requests 616, the modified bid requests, bid offers, and any modified bid offers may be stored in a bid history database 608.

When the DSPs 614 receive the bid requests, the DSPs 614 may or may not respond back with bid offers. The bid arbitrage engine 606 forwards all bid offers as received from the DSPs 614 back to the originating SSP 612. If one of the bid offers wins the auction, the SSP 612 or its publishing partner sends a win notification 620 and an impression 622 is counted by the ad server for each user that has seen the ad.

In certain embodiments, a revenue reconciliation and audit module 610 is used to post process all transactions and reconcile with the SSPs 612. On a regular basis, the SSPs 612 are expecting a certain price for the bid requests that were put out for auction. The B3E 600 and, more specifically, the revenue reconciliation and audit module 610 may compare a net value of the daily auctionable inventory with a net value of the sold inventory (e.g., at a differential price determined during arbitrage, as described above), and then reconcile the sold with the bought. If there are differences in what was expected, those differences may be itemized separately for further review, approval, and/or resolution.

Advantageously, the B3E 600 makes it possible to monetize audience data during a real-time bidding (RTB) transaction. For example, an RTB bid request may arrive at the B3E 600 and have a minimum acceptable bid of $1.00. The B3E 600 may, however, look up data regarding zip codes, IP addresses, and/or households involved in the bid, and determine that the B3E has additional information (e.g., a ranking of household(s) in a particular demographic segment) that might help a buyer. The systems and method described herein may then increase the minimum bid in the bid request, attach the additional information from the B3E, and forward the new minimum bid to a buyer with the higher minimum bid. The difference between the previous minimum bid from the originating seller and the new minimum bid represents a monetization.

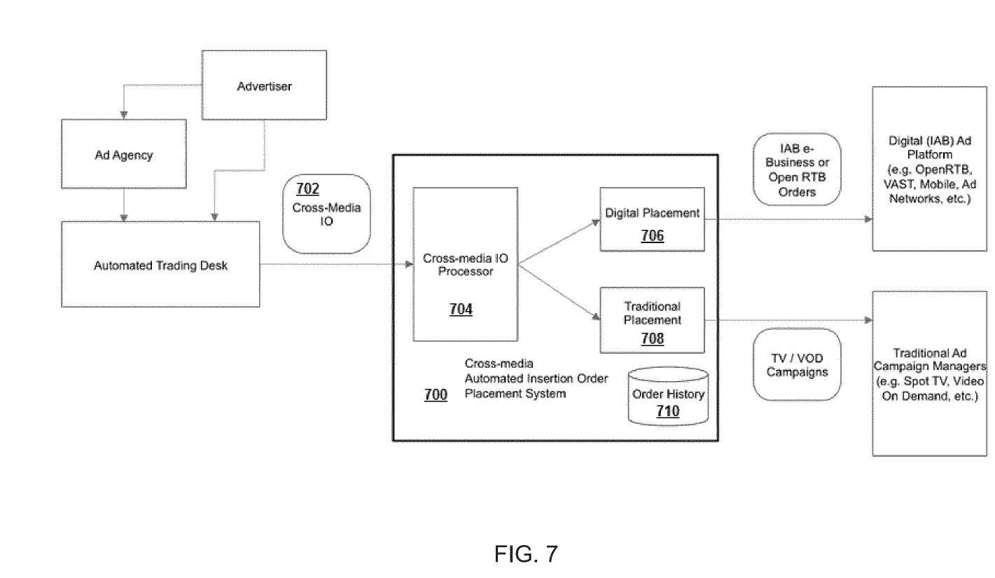

FIG. 7 is a schematic diagram of a cross-media automated insertion order placement system 700, in accordance with certain embodiments. The system 700 includes a cross-media insertion order 702 that is or includes a set of instructions that are created and described for processing. The system 700 also includes a cross-media insertion order processor 704 that interprets the instructions and separates the instructions into: (a) instructions that are applicable to traditional media types such as TV, video on demand, or other traditional media execution channels; and (b) instructions that are applicable to digital media types such as Internet display, mobile, video, and/or search, which may or may not be or include Real Time Bidding (RTB) orders.

Traditional insertion orders are scheduled and processed for placement by a traditional placement module 708. For example, to place an order in local TV spot markets, the traditional placement module 708 may be a cable industry specific campaign management module capable of communicating with cable industry's local spot ad placement systems. In some examples, the system 700 includes more than one traditional placement module 708. The number of traditional placement modules 708 may depend on a number of traditional media ad insertion systems connected to the system 700.

Digital insertion orders are scheduled and processed for placement by a digital placement module 706. For example, to place the order to demand side platform (DSP) in an OpenRTB ad insertion environment, the digital placement module 706 may communicate the placement instructions with that DSP. The system 700 may include more than one digital placement module 706, depending on a number of digital media ad insertion systems connected to the system 700.

The system 700 also includes an order history module 710. The order history module 710 maintains a history of all orders received by 704 and placed by 706 and 708.

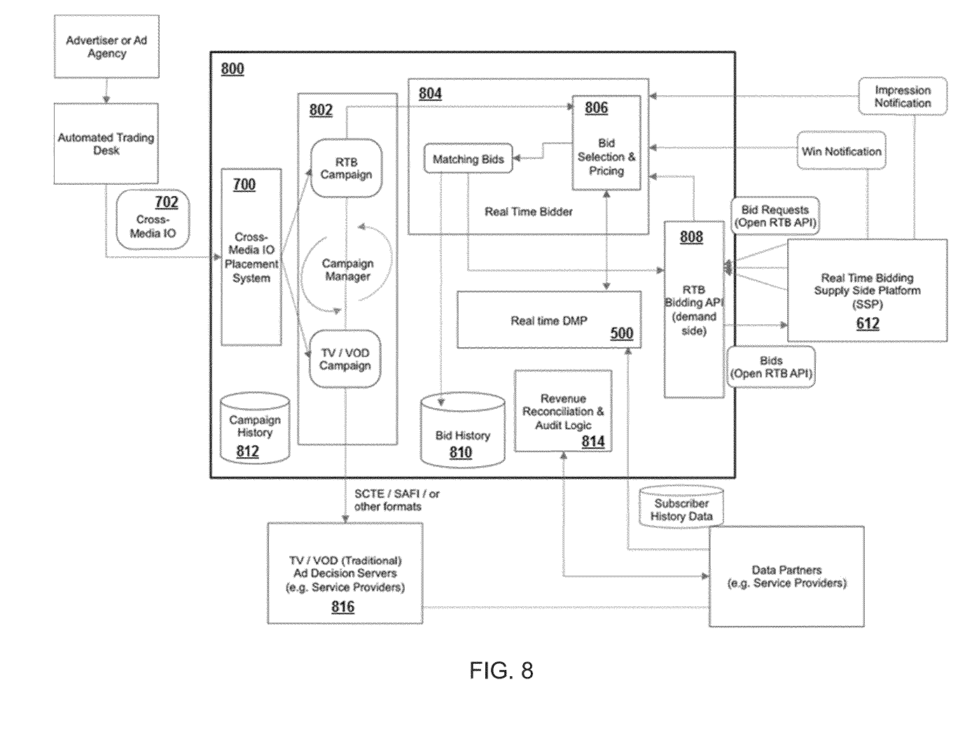

FIG. 8 is a schematic diagram of an example fully integrated real-time bidding (RTB) system that executes cross-media campaigns defined by cross-media IO and makes media spend decisions in multiple media channels in real-time as the campaigns progress. The system includes or utilizes a cross-media order management and advertisement execution system 800. The system 800 includes a cross-media campaign manager 802 that can manage both an RTB campaign as well as a live TV or video on demand (VOD) campaign. The system 800 also includes a real-time bidder 804 to execute ad purchasing logic in real-time in a digital RTB ad purchasing market. The real-time bidder 804 includes a bid selection and pricing sub-system 806. In the depicted example, the system 800 includes an implementation of an RTB demand side API 808 (e.g., as agreed to between the demand side and the supply side in a digital RTB market), a bid history subsystem 810, a campaign history subsystem 812, and a revenue logic and reconciliation subsystem 814.

After receiving pre-processed placement instructions from the cross-media automated insertion order placement system 700, for each individual media type (e.g., digital media placement instructions for digital real-time bidding (RTB) ad placements and TV or video on demand placement instructions for a TV media campaign), the cross-media campaign manager 802 coordinates between two campaigns (i.e., an RTB campaign and a TV/VOD campaign) in real-time. The cross-media campaign manager 802 relies on information such as media habit and exposure, as well as the cross-media insertion order 702, to determine changes in the ad placement campaigns in either of the two media types, in real-time. The cross-media campaign manager 802 coordinates with the bid selection and pricing sub-system 806 of the real-time bidder 804 to discover ad opportunities in Internet via RTB that are synergistic with TV, in real-time. The cross-media campaign manager 802 also interacts with TV ad decision servers 816 in the service provider's ad insertion infrastructure using, for example, standards based protocols defined by the Society of Cable and Telecommunications Engineers or other industry body. The cross-media campaign manager 802 can modify campaign instructions by sending a new campaign information package to the TV ad decision servers 816 to match with any synergistic Internet media ad opportunities discovered via the real-time bidder 804.

The real-time bidder 804 and its subsystem, the real-time bid selection and pricing subsystem 806, is responsible for executing an Internet media ad purchasing plan in real-time as defined by the cross-media campaign manager 802. The real-time bidder 804 preferably complies with an RTB communication protocol established by the supply side platform 612. The communication protocol may be, for example, an IAB standard protocol such as the OpenRTB protocol or other suitable RTB protocol. The real-time bidder 804 receives bid requests from a real-time bidding API demand side client 808. The real-time bidder 804 responds to these bid requests with zero or more bids placed against it, depending on logic used by the real-time bid selection and pricing subsystem 806 for bid selection and pricing. If a bid is placed for a given bid request, a win notification indicating that the auction was won or a loss notification indicating that the auction was not won are received asynchronously by the real-time bidder 804 from third party systems such as the supply side platform 612. If the real-time bidder 804 wins the auction, an impression notification that an ad was displayed to a plurality of impressions may be received by the real-time bidder 804 from third party systems (e.g., the supply side platform 612).

In general, the real-time bid selection and pricing subsystem 806 is an intelligent subsystem that can query the real-time data management platform (DMP) 500 for more information about the audiences emanating from the TV media domain, in accordance with the description herein. Using information from the real-time DMP 500 and the campaign instructions provided by the cross-media campaign manager 802, the real-time bid selection and pricing subsystem 806 makes decisions about which bid requests to respond to, which ads to select for placement, and what price to bid.

In the depicted example, the system 800 also includes a bid history system 810 that records details about any bids received and responded to and details about the campaigns they were part of. A campaign history system 812 is maintained for recording all details about the campaign instructions that were generated and sent to either TV or Internet RTB ad decision servers. Any changes and/or updates that may happen to the campaigns in real-time during the execution of the system 800 are also recorded in the campaign history system 812. A revenue reconciliation and audit logic system 814 is included for bookkeeping monetary values of transactions completed by the system 800.

In various embodiments, the systems and methods described herein are used to assign a household to be a member of one or more groups classified using primarily demographic attributes (e.g., age, gender, ethnicity, income, education level, marital status, number of children, and employment status) called segments. The systems and methods may also assign a household to be a member of one or more groups called lookalikes, which are discovered or identified primarily based on similarity of viewing habits and/or psychographic attributes, such as mood, theme, and/or genre of programs viewed. In this way, a household may be readily compared and/or contrasted with other households, based on demographics and/or media viewing habits.

Embodiments of the systems and methods described herein may utilize a computer system, which may include a general purpose computing device in the form of a computer including a processor or processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between components, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Mac OS operating system, Google Android operating system, Apple iOS operating system, or another operating system or platform.

At a minimum, the memory includes at least one set of instructions that is either permanently or temporarily stored. The processor executes the instructions that are stored in order to process data. The set of instructions may include various instructions that perform a particular task or tasks. Such a set of instructions for performing a particular task may be characterized as a program, software program, software, engine, module, component, mechanism, or tool.

The system may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Basic, C, C++, C#, CSS, HTML, Java, SQL, Perl, Python, Ruby and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, Storage Area Networking devices, solid state drives, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed microprocessor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user may enter commands and information into the systems that embody the invention through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

The systems that embody the invention may communicate with the user via notifications sent over any protocol that can be transmitted over a packet-switched network or telecommunications network. By way of example, and not limitation, these may include SMS messages, email (SMTP) messages, instant messages (GChat, AIM, Jabber, etc.), social platform messages (Facebook posts and messages, Twitter direct messages, tweets, retweets, etc.), and mobile push notifications (iOS, Android).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Although internal components of the computer are not shown, those of ordinary skill in the art will appreciate that such components and the interconnections are well known. Accordingly, additional details concerning the internal construction of the computer need not be disclosed in connection with the present invention.

It is understood that the methods and systems described above may contain software and hardware connected to the Internet via a network. Computing devices are capable of communicating with each other via the Internet, and it should be appreciated that the various functionalities of the components may be implemented on any number of devices.

The invention may be practiced using any communications network capable of transmitting Internet protocols. A communications network generally connects a client with a server, and in the case of peer to peer communications, connects two peers. The communication may take place via any media such as standard telephone lines, LAN or WAN links (e.g., T1, T3, 56kb, X.25), broadband connections (ISDN, Frame Relay, ATM), wireless links (802.11, Bluetooth, 3G, CDMA, etc.), and so on. The communications network may take any form, including but not limited to LAN, WAN, wireless (WiFi, WiMAX), near-field (RFID, Bluetooth). The communications network may use any underlying protocols that can transmit Internet protocols, including but not limited to Ethernet, ATM, VPNs (PPPoE, L2TP, etc.), and encryption (SSL, IPSec, etc.)

The invention may be practiced with any computer system configuration, including hand-held wireless devices such as mobile phones or personal digital assistants (PDAs), multiprocessor systems, microprocessor-based or programmable consumer electronics, minicomputers, mainframe computers, computers running under virtualization, etc.

The invention may also be practiced in distributed computing environments where tasks are performed by remote processing devices that are linked through a communications network. In a distributed computing environment, program modules may be located in both local and remote computer storage media including memory storage devices.

The invention's data store may be embodied using any computer data store, including but not limited to, relational databases, non-relational databases (NoSQL, etc.), flat files, in memory databases, and/or key value stores. Examples of such data stores include the MySQL Database Server or ORACLE Database Server offered by ORACLE Corp. of Redwood Shores, Calif., the PostgreSQL Database Server by the PostgreSQL Global Development Group of Berkeley, Calif., the DB2 Database Server offered by IBM, Mongo DB, Cassandra, or Redis.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A computer-implemented method for managing and analyzing subscriber history data present within a service provider infrastructure, the method comprising:
removing elements from the subscriber history data that allow the data to be attributed to a household;
aggregating the subscriber history data by an anonymous attribute;
deriving a predictive model for a plurality of households;
ranking each household in the plurality of households relative to other households according to at least one household attribute;
in real-time, providing advertisers with access to the ranked data such that the advertisers can improve marketing metrics for advertisements delivered to the households; and
receiving monetary compensation for providing access to the ranked data.

2. The method of claim 1, wherein the service provider comprises at least one of a multiple service operator, a cable service provider, a telephone company, a mobile network operator, or a wireless service provider.

3. The method of claim 1, wherein the household comprises an individual subscriber.

4. The method of claim 1, wherein removing elements from the subscriber history data comprises removing personally identifiable information from the subscriber history data.

5. The method of claim 1, wherein the predictive model is configured to predict media habit and media exposure for at least one household.

6. The method of claim 1, wherein the at least one household attribute comprises at least one of a media habit and a media exposure.

7. The method of claim 1, wherein ranking each household relative to other households comprises assigning a formula to predict a household's media habit and exposure.

8. The method of claim 1, wherein ranking each household relative to other households comprises assigning a household to at least one of a demographic segment and a group of lookalike households having similar media viewing habits.

9. A system comprising:
a computer readable medium having instructions stored thereon; and
a data processing apparatus configured to execute the instructions to perform operations comprising:
removing elements from the subscriber history data that allow the data to be attributed to a household;
aggregating the subscriber history data by an anonymous attribute;
deriving a predictive model for a plurality of households;
ranking each household in the plurality of households relative to other households according to at least one household attribute;
in real-time, providing advertisers with access to the ranked data such that the advertisers can improve marketing metrics for advertisements delivered to the households; and
receiving monetary compensation for providing access to the ranked data.

10. The system of claim 9, wherein the service provider comprises at least one of a multiple service operator, a cable service provider, a telephone company, a mobile network operator, or a wireless service provider.

11. The system of claim 9, wherein the household comprises an individual subscriber.

12. The system of claim 9, wherein removing elements from the subscriber history data comprises removing personally identifiable information from the subscriber history data.

13. The system of claim 9, wherein the predictive model is configured to predict media habit and media exposure for at least one household.

14. The system of claim 9, wherein the at least one household attribute comprises at least one of a media habit and a media exposure.

15. The system of claim 9, wherein ranking each household relative to other households comprises assigning a formula to predict a household's media habit and exposure.

16. The system of claim 9, wherein ranking each household relative to other households comprises assigning a household to at least one of a demographic segment and a group of lookalike households having similar media viewing habits.

17. A computer program product stored in one or more storage media for controlling a processing mode of a data processing apparatus, the computer program product being executable by the data processing apparatus to cause the data processing apparatus to perform operations comprising:
removing elements from the subscriber history data that allow the data to be attributed to a household;
aggregating the subscriber history data by an anonymous attribute;
deriving a predictive model for a plurality of households;
ranking each household in the plurality of households relative to other households according to at least one household attribute;
in real-time, providing advertisers with access to the ranked data such that the advertisers can improve marketing metrics for advertisements delivered to the households; and
receiving monetary compensation for providing access to the ranked data.

18. The computer program product of claim 17, wherein the service provider comprises at least one of a multiple service operator, a cable service provider, a telephone company, a mobile network operator, or a wireless service provider.

19. The computer program product of claim 17, wherein the household comprises an individual subscriber.

20. The computer program product of claim 17, wherein removing elements from the subscriber history data comprises removing personally identifiable information from the subscriber history data.

21. The computer program product of claim 17, wherein the predictive model is configured to predict media habit and media exposure for at least one household.

22. The computer program product of claim 17, wherein the at least one household attribute comprises at least one of a media habit and a media exposure.

23. The computer program product of claim 17, wherein ranking each household relative to other households comprises assigning a formula to predict a household's media habit and exposure.

24. The computer program product of claim 17, wherein ranking each household relative to other households comprises assigning a household to at least one of a demographic segment and a group of lookalike households having similar media viewing habits.
